(19) United States
(12) Patent Application Publication
(10) Pub. No.: US 2004/0109944 A1
(43) Pub. Date: Jun. 10, 2004

(54) Continuous process for the preparation of filled rubber granules

(75) Inventors: Matthias Schmitt, Neckargemuend (DE); Udo Goerl, Recklinghausen (DE); Reinhard Stober, Hasselroth (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/722,414

(22) Filed: Nov. 28, 2003

(30) Foreign Application Priority Data
Dec. 5, 2002 (DE) 102 56 790.5

(51) Int. Cl. B05D 7/00

(52) U.S. Cl. 427/212

(57) ABSTRACT

A process for the continuous preparation of filled rubber granules, composed of a mixture of one or more polymers with one or more fillers, which includes precipitating the rubber onto the surface of the filler in one or more continuous reactors.

### BACKGROUND OF THE INVENTION

1. Field of the Invention

The invention relates to a continuous process for the preparation of filled rubber granules from rubber latex emulsions by precipitation from aqueous mixtures.

2. Description of the Related Art

A wide variety of publications has appeared relating to the applications for rubber powders, and methods for their production.

The interest in rubber powder/filler masterbatches is driven by processing technology used in the rubber industry. Conventional processes incur high costs for energy, time, and personnel when preparing rubber mixtures. One of the prime reasons for this is that crude rubber is supplied in bale form and its processing requires mechanical incorporation and dispersion of large amounts of reinforcing fillers (industrial carbon blacks, silicas, etc.) into the rubber phase.

In industrial processes this is accomplished by mechanical kneading which is generally carried out batchwise in large internal mixers or on roll mills, generally in two or more stages.

These processes are very complicated and the processing industry is therefore always interested in alternate processes or alternate types of raw materials. New processing systems, such as continuous mixing processes, often require supply of the raw material in a different form such as a powder or granule form.

Powder rubber technology has long been regarded as the most suitable approach to the introduction of new mixing technologies. It combines the need for pre-incorporation of filler with a free-flowing rubber powder or free-flowing rubber granules, suitable for use in the continuous mixing processes which are well-established technology in the plastics industry.

Conventional processes prepare rubber powder by precipitation from a mixture of a filler suspension (e.g. carbon black or silica) and a rubber latex emulsion, by lowering the pH with the aid of appropriate Brönsted or Lewis acids (DE C 37 23 213 and 214, DE C 28 22 148, DE 198 15 453.4, DE 198 16 972.8).

The addition of from 0.5 to 10 phr of water-soluble salts of a metal of Groups IIa, IIb, IIIa or VIII of the Periodic Table of the Elements to the filler suspension is generally regarded as essential. This classification of the groups corresponds with the IUPAC recommendation (see Periodisches System der Elemente [Periodic Table of the Elements], Verlag Chemie, Weinheim, 1985, incorporated herein by reference). Typical compounds are magnesium chloride, zinc sulfate, aluminum chloride, aluminum sulfate, iron chloride, iron sulfate, cobalt nitrate and nickel sulfate, preference being given to the salts of aluminum, in particular aluminum sulfate.

The addition of amounts of up to 5 phr of an alkali metal silicate is also recommended in some cases.

The processes known from the prior are orientated towards carrying out this rubber coagulation batchwise in two or more stages (e.g. DE 37 23 213 and 214, DE 28 22 148, DE 198 15 453.4, DE 198 16 972.8). A particularly complicated feature of batch processing is the division of the filler into two or more fractions (“splitting”) to produce a release layer securely bonded to the granule matrix around every particle. The division of the process into up to three steps in which in some cases the pH is also varied makes these processes very complicated and expensive.

Another process is known as “tube precipitation” (e.g. DE 100 08 877.5). This advanced process utilizes a mixing tube as a reaction space in which the filler suspension (where appropriate previously treated with the abovementioned precipitation chemicals) and the rubber emulsion or latex are mixed and the rubber is coagulated. In some cases this reaction is initiated by an additional feed of precipitation chemicals into the “precipitation tube”. However, such a process utilizes the tubular reactor merely in the form of a first stage of the reaction. The further addition of filler suspension and of precipitation chemicals takes place in a downstream mixer operated as a batch apparatus.

A substantial disadvantage of such a partial batch process is the fact that the downstream stirred tank is again operated batchwise. In addition, the latex is responsible for a considerable risk of blockage in the “precipitation tube”.

Further developments at continuous preparation in a tubular reactor have been described in EP 1 035 155 A1. In the process described therein, the filler suspension and the rubber emulsion are fed continuously to a tubular reactor. Other filler fractions and precipitation chemicals are metered at various sections along the length of the tube. Flow restrictors produce a pressure rise in the individual sections, permitting control of mixing and rubber coagulation. However, closer study of this process reveals considerable problems, the effect of which is that this process can give complete rubber coagulation only in unusual cases. The tubular reactors described by way of example have very low flow rates and give inadequate mixing of filler and rubber emulsion and therefore very inhomogeneous products. In addition, the very short residence times (about 5 s) appear to be insufficient to complete the coagulation of the rubber (in particular of natural latex). As with the “precipitation tube” described above, this would lead to a requirement for a downstream mixer.

Another expected limitation of this process is a fixed residence time in the apparatus due to the fixed tube length. This may restrict uses of the apparatus to only one particular mixing specification and, furthermore, may make the apparatus very susceptible to variations in the properties of the starting materials, e.g. the coagulation behavior of the rubber emulsion.

In addition, considerable blockage problems may be expected due to the properties of the latex and due to the fact that a tube is a vessel with very high specific surface area (ratio of wall area to reactor volume). A result of very low flow rates and the incorporation of additional constrictions (flow restrictor sections and static mixers), is an increased risk of blockage and inability to prepare the products reproducibly.

Another process known from the literature (U.S. Pat. No. 4,265,939) is primarily for the preparation of rubber particles which are coated with a polymer suspension (e.g. polystyrene) during the multistage precipitation process, in order to avoid caking of the product. This process is again a continuous process carried out in a mixing apparatus similar to a tube. Here again, the reaction is completed in a mixer. The aim of the process is not the preparation of homogeneous filler/rubber preparations in granule form but rather the preparation of rubber granules.

### SUMMARY OF THE INVENTION

Accordingly, one object of the present invention is a precipitation and preparation process permitting avoidance of the problems described above including batchwise operation, apparatus blockage, tolerance in relation to variations in properties of starting materials or limitation on variations in formulation.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a continuous process for preparing rubber powders;

FIG. 2 shows a continuous process having two precipitation reactors.

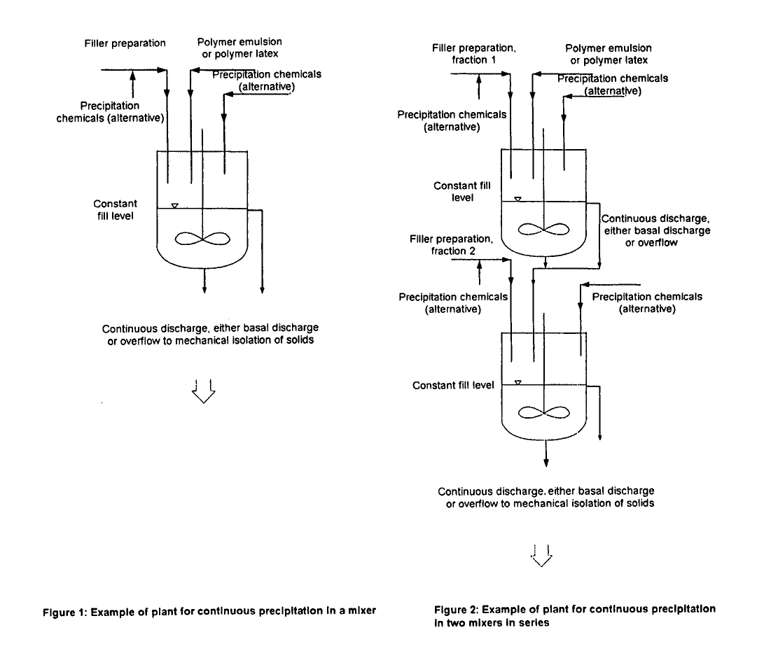

### DESCRIPTION OF THE PREFERRED EMBODIMENTS

The process described here and in the appended claims solves these problems in a surprisingly simple manner by using a continuous stirred tank reactor. The starting materials (filler suspension and rubber emulsion) are fed via separate lines, and mixed homogeneously with intensive stirring. Addition of the precipitants into the filler suspension permits extremely homogeneous distribution and efficient utilization of these additives. Thus making it very easy to avoid overfeeds. Latex coagulation takes place substantially on contact of the emulsion droplets with the surface of the filler. This ensures very homogeneous distribution of rubber and filler. If the product formulation requires further addition of additives, e.g. process oil or other mixing additives conventionally used in the rubber industry, the further additives may also be added directly to the reaction vessel. There are a number of ways of keeping the fill level of the reaction vessel constant, e.g. continuous discharge through a basal valve, or utilization of an overflow.

When this is apparatus is used under specific reaction conditions (type of stirrer, flow conditions in reaction vessel, and also adjustment of solids concentration and controlled feed of the precipitation chemicals) preparation of a fine-particle filler/rubber composite which is a free-flowing loose material is accomplished.

The following are preferred reaction conditions in the mixer. Mixtures filled with industrial carbon black can be prepared on a laboratory scale in a mixer (from 10-30 l capacity) equipped with a two-stage MIG stirrer or, as an alternative, with a single-stage propeller stirrer.

If the MIG stirrer is used, preferred peripheral speeds are about 2-3 m/s, giving Reynolds numbers of about 1-3×10³. The solids concentration may be about 10%, with an average residence time in the reactor of about 7-25 min, and a pH value of about 4.

If a propeller stirrer is used, preferred peripheral speeds are about 8-10 m/s, giving Reynolds numbers of about 3-5×10³. The solids concentration may be about 10%, with an average residence time in the reactor of about 7-12 min, and a pH value of about 4.

On pilot-plant scale, the studies using the carbon-black-filled products were carried out in a mixer (400-600 l capacity) equipped with a single-stage propeller stirrer. In this case, the preferred peripheral speeds are about 8-12 m/s, giving Reynolds numbers of about 7-12×10³. The solids concentrations were about 8-12%, the average residence time in the reactor was about 10-15 min, and the pH value was about 4.

The lower limits stated here were determined for the products based on E-SBR/carbon black, and the upper limits were determined for NR/carbon black.

When preparing products filled using a silica/silane system (S/Si), the process parameters are preferably adjusted as follows:

Experiment carried out in a mixer with capacity about 30 l, equipped with a propeller stirrer. The preferred peripheral speeds are about 8-10 m/s, giving Reynolds numbers of about 3-5×10³. The solids concentration was about 16-20%, the average residence time in the reactor was less than one minute, and the pH value was about 4.

As shown in particular by the studies on carbon-black filled products, preparation is possible using various mixing units, as long as process conditions are adjusted accordingly. The conditions described here are therefore a particularly suitable embodiment.

From this experience it can therefore been seen that suitable mixing assemblies are any of the high-speed mixing assemblies which can be operated continuously. Another possibility is to carry out the reaction in suitable comminuting machinery (e.g. a disperser using a rotor-stator system), or in a granulator (e.g. granulators using high-speed rotors, for example as used to granulate fillers).

Another embodiment permits addition of another filler fraction into a downstream mixer, likewise continuously operated (described in DE 198 15 453.4 and DE 198 16 972.8 those portions of each which are relevant to continuous mixing of filler fractions are incorporated herein by reference). This mixer cascade permits, where required, the fully continuous deposition of a filler layer securely bonded to the matrix of granules, around every particle.

This procedure is particularly suitable when preparing carbon-black-filled products. To this end, about 5% of the filler fraction was fed into a second mixer in series of mixers for an E-SBR rubber filled with about 76 phr of N234, on pilot-plant scale. When preparing products based on natural rubber (NR) for which the selected filler levels were 47 phr of industrial carbon black, about 40% of the filler fraction was fed into the second mixer in series. Gentle stirring (e.g. using an impeller stirrer) was used for both products, the average residence time in the apparatus being up to 120 min in the case of the E-SBR/carbon black system and up to 480 min in the case of the NR/carbon black system.

When preparing products which had low filler level and were based on polymers with a degree of tack, e.g. natural rubber, it has proven advantageous to meter a further filler fraction into a third stirred tank in series. For example, about 5% of the entirety of the filler was metered continuously into the third mixer in series for an NR filled with 47 phr of N234.

However, it has been found that it is not absolutely essential to use a second, or a third mixer in series. As described above, this mainly depends on the desired product. However, other measures can also be used to achieve this purpose (see Example 4), an example being the subsequent application of a coating layer in a solids mixer.

Since the pH of the filler is low (due to addition of the precipitant), the pHs in the reaction vessel become lower as the number of apparatuses increases. This effect, which brings about further stabilization of the granules prepared in the vessels in series, can be further promoted by appropriately adapting the pHs in each of the vessels in series. A preferred lowering of the pH by from 0 to 0.4 was determined in the studies carried out.

The studies carried out also showed that it is possible to add further additives (process oil, antioxidant, stabilizers, etc.) without further adding to processing cost. In the case of lipophilic fillers (e.g. industrial carbon black) it is particularly advantageous to add oil to the filler suspension. In the case of lipophilic/hydrophilic fillers (e.g. silica) the oil may preferably be added to the rubber emulsion directly prior to the mixer or directly into the reaction vessel.

The process described here is suitable for preparing fine-particle filler/rubber compounds based on a wide variety of known fillers and polymers.

The filler content may be from 20 to 99.9% by weight based on the rubber granules. The materials include, in particular, synthetic white fillers and industrial carbon blacks known in rubber processing, an example being precipitated or fumed silicas, or naturally occurring fillers, e.g. silicious chalk, clay, etc.

Particularly suitable materials are carbon blacks generally used in rubber processing, or carbon blacks whose surface has been modified by oxidative post-treatment. A combination of fillers may be used.

These include furnace, gas, thermal, and flame blacks with an iodine adsorption value of from 5 to 1000 m²/g, with a CTAB value of from 15 to 600 m³/g, with a DBP adsorption of from 30 to 400 ml/100 g, and with a 24M4 DBP value of from 50 to 370 ml/100 g.

In one preferred embodiment, the products of the invention comprise carbon blacks as in, for example, DE 198 40 663, with dynamic properties improved over standard carbon blacks (those portions descending carbon blacks incorporated herein by reference).

It is particularly preferable to use carbon blacks with DBP values greater than 100 ml/100 g. The carbon blacks may be wet-beaded, dry-beaded, or used in powder form.

Another possibility, however, is to carry out the preparation using other solids, e.g. absorbents and adsorbents, inter alia activated carbon or high-surface-area industrial carbon blacks. If use is made of the industrial carbon blacks known from the prior art, these are advantageously taken from the earliest possible stage in the production process in the form of wet fluffy carbon black or wet granules when used.

Precipitated silicas known in the rubber art are also suitable (the filler used as starting material preferably being a filter cake washed until freed from salts or, in one particular embodiment, a silica precipitation suspension produced from waterglass and sulfuric acid having high salt content, in particular comprising sodium sulfate), or fumed silicas. These generally have an N₂ surface area determined by the BET method of from 35 to 700 m²/g, a CTAB surface area of from 30 to 500 m²/g, and a DBP adsorption of from 150 to 400 ml/100 g.

If the materials are naturally occurring white fillers, e.g. silicious chalks or clays, these generally have an N₂ surface area of from 2 to 35 m²/g.

Other materials which may, where appropriate, be present in the rubber granules of the invention, besides or in addition to the fillers mentioned, are processing and vulcanization auxiliaries known in the polymer and rubber industry, e.g. zinc oxide, zinc stearate, stearic acid, polyalcohols, polyamines, plasticizers, stabilizers with respect to aging caused by heat, light, or oxygen, or ozone, reinforcing resins, flame retardants, such as Al(OH)₃ and Mg(OH)₂, pigments, various crosslinking chemicals, and, where appropriate, sulfur, in the concentrations usual in rubber technology.

Other materials which may be present include reinforcing additives for rubber vulcanizates, such as those prepared from the liquid organosilanes of U.S. Pat. No. 3,842,111 with silicatic fillers (DE C 22 55 577 and U.S. Pat. No. 3,997,356 those portions of each of which is relevant to liquid organosilanes and/or silactic fillers are incorporated herein by reference). The rubber granules of the invention may, where appropriate, also comprise these reinforcing additives, in addition to the fillers mentioned.

These are organosilicon compounds of the general formula

[R¹ₙ(RO)₃₋ₙSi—(Alk)ₘ-(Ar)p]q[B] (I)

R¹ₙ(RO)₃₋ₙSi-(Alkyl) (II),

or

R¹ₙ(RO)₃₋ₙSi-(Alkenyl) (III)

where

B is —SCN, —SH, —Cl, —NH₂ (if q=1) or

—Sx- (if q=2)

R and R¹ are an alkyl group having from 1 to 4 carbon atoms, branched or unbranched, or the phenyl radical, where each of the radicals R and R¹ may have the same or a different meaning, preferably an alkyl group,

n is 0, 1, or 2

Alk is a divalent straight-chain or branched carbon radical having from 1 to 6 carbon atoms,

m is 0 or 1

Ar is an arylene radical having from 6 to 12 carbon atoms

p is 0 or 1, with the proviso that p and n are not simultaneously 0,

x is a number from 2 to 8,

Alkyl is a saturated monovalent straight-chain or branched hydrocarbon radical having from 1 to 20 carbon atoms, preferably from 2 to 8 carbon atoms,

Alkenyl is an unsaturated monovalent straight-chain or branched hydrocarbon radical having from 2 to 20 carbon atoms, preferably from 2 to 8 carbon atoms.

If these compounds are water-soluble they are generally used in the form of solutions. Otherwise, they are used in the form of emulsions. These emulsions may also be formed in the presence of the silica suspension. Mixtures of water soluble and water insoluble compounds may be used.

It has been found that the following types of rubber, individually or in a mixture with one another, can be used and can be prepared in the form of aqueous emulsions: natural rubber, emulsion SBR with styrene content of from 10 to 50%, butyl-acrylonitrile rubber, butyl rubbers, terpolymers of ethylene, propylene (EPM) and unconjugated dienes (EPDM), butadiene rubbers, SBR, prepared by solution polymerization, with styrene contents of from 10 to 25%, and also with contents of from 20 to 55% of 1,2-vinyl constituents, and isoprene rubbers, in particular 3,4-polyisoprene.

The solvent content of polymers prepared by solvent processes requires particular precautionary measures, where appropriate.

Other elastomers which may be used, individually or in a mixture, besides the rubbers mentioned, include: carboxy rubbers, epoxy rubbers, trans-polypenteneamers, halogenated butyl rubbers, rubbers derived from 2-chlorobutadiene, ethylene-vinyl acetate copolymers, epichlorohydrins, and also, where appropriate, chemically modified natural rubber, e.g. epoxidized grades.

The solids content of the rubber emulsions (or rubber solutions) is generally from 10 to 65%, preferably from 15 to 30%.

The rubber powders obtained in the procedure described above, mixed with water, are then dewatered mainly by mechanical means using, for example, a belt filter or a filter press.

Subsequently, a thermal drying procedure is carried out until the residual moisture level is ≦3%, preferably ≦1%. The drying is preferably carried out in a fluidized bed. If necessary, e.g. if dewatering by means of a filter press produces a sheet of filter cake, the product may be further processed by using a comminution or granulation apparatus complying with the requirements prior to the drying process (particle size distribution, proportion of fines).

In one preferred embodiment, it has proven advantageous to powder, i.e. dry-coat, the finished, dried rubber powder with suitable products used in the rubber industry for further reduction of tack. Materials which have proven suitable are, inter alia, stearic acid, silicas, and in particular zinc oxide, in amounts of from 0.1 to 3 phr, in particular from 0.25 to 1 phr. The coating layer is applied to the rubber powder grains in suitable powder mixers, i.e. with avoidance of shear, to prevent breakdown of the grains.

The coating layer applied permits storage over prolonged periods at relatively high compaction, e.g. in a silo, without caking.

If the rubber granules of the invention are used as a masterbatch for the rubber industry, the filler content is generally from 20 to 200 phr, and in one preferred embodiment from 30 to 100 phr.

For use in environmental technology, filler levels which have proven successful are markedly higher, in the range from 100 to 2000 parts per 100 parts of rubber (phr). Here, the polymer assumes substantially the function of the binder.

### EXAMPLES

Raw materials used in the preparation process

E-SBR—1500 Emulsion styrene-butadiene latex with 23.5% styrene content (BSL)

E-SBR—1712 Emulsion styrene-butadiene latex with 23.5% styrene-content (BSL)

Process oil Enerthene 1849-1

Natural latex Low ammonia CV field latex

Ultrasil 7000 Precipitated silica with an N₂ surface area (BET) of 185 m²/g and with improved dispersing properties (Degussa AG) in the form of filter cake

Si 75 Bis(triethoxysilylpropyl)disulfane (Degussa AG)

Marlipal 1618/25 Emulsifier: fatty alcohol polyethylene glycol ether (Condea)

Corax N234 Activated carbon black in the form of wet fluffy carbon black (Degussa AG)

### Example 1

Preparation of Rubber Powder Based on E-SBR 1500, Ultrasil 7000 Precipitation Suspension, and Si 75

A stable suspension of 32.9 kg (TS) of Ultrasil 7000 (filter cake), 2.63 kg of Si 75 (corresponds to 8 parts, based on 100 parts of dry silica), 329 g of Marlipal 1618/25 (corresponds to 1%, based on silica), and 12.1 kg of 9.3% strength aluminum sulfate solution was prepared, with stirring, in 286 l of water.

A pump (about 1200 kg/h) was used to meter this suspension simultaneously with the rubber emulsion (E-SBR 1500, 20.3% solids) to the precipitation vessel. Total throughput was 2180 kg/h. The acid-catalyzed latex coagulation onto the filler particles was carried out with vigorous stirring at a pH of 4. The product had an average residence time of about 0.8 min in the 30 l mixer.

A centrifuge or a filter press was then used to isolate the solid from the serum, the solid was then dried in a fluidized bed to a residual moisture level below 1%. Further processing of the filter cake comprised comminution using a granulator to a particular size of about 4 mm prior to the drying process.

After the drying process, the product comprised 100 phr (parts per hundred parts of rubber) of solid rubber, 73 phr of Ultrasil 7000, and 8 parts of Si 75 on 100 parts of silica.

Evaluation of the specimen for performance characteristics and in the form of loose material revealed no differences on comparison with the reference products (e.g. products prepared as in DE 198 43 301.8).

### Example 2 (FIG. 2)

Preparation of Rubber Powder Based on E-SBR 1500, Corax N234 (Wet Fluffy)

A stable suspension of 106.4 kg (TS) of Corax N234 (wet fluffy) and 5.15 kg of 9.5% strength aluminum sulfate solution was prepared, with stirring, in 2020 l of water.

A pump (about 1540 kg/h) was used to meter this suspension simultaneously with the rubber emulsion (E-SBR 1500, 20.4% solids) to the precipitation vessel. Total throughput was 2240 kg/h. The acid-catalyzed latex coagulation onto the filler particles was carried out with vigorous stirring at a pH of 4, with addition of 1.5 kg of sulfuric acid (20%). The product has an average residence time of about 11 min in the 400 l mixer.

The product was transferred continuously into a second mixer, into which about 100 kg/h of filler suspension were also introduced. The average residence time in the second mixer was about 90 minutes. This process results in application of the coating layer securely bonded to the particles, to reduce tack.

A centrifuge was then used to separate the solid from the serum, and the solid was dried to a residual moisture level below 1% in a fluidized bed.

After the drying process, the product comprised 100 phr (parts per hundred parts of rubber) of solid rubber, and 76 phr of N234 carbon black.

Evaluation of the specimen for performance characteristics and in the form of loose material revealed no differences on comparison with the reference products (e.g. products prepared as in DE 100 08 877.5).

### Example 3 (FIG. 2)

Preparation of Rubber Powder Based on E-SBR 1712, Enerthene, Corax N234 (Wet Fluffy)

A stable suspension of 98.8 kg (TS) of Corax N234 (wet fluffy), 32.5 kg of Enerthene, 15 kg of 9.5% strength aluminum sulfate solution was prepared, with stirring, in 2100 l of water.

A pump (about 1570 kg/h) was used to meter this suspension simultaneously with the rubber emulsion (E-SBR 1712, 19.7% solids) to the precipitation vessel. Total throughput was 2240 kg/h. The acid-catalyzed latex coagulation onto the filler particles is carried out with vigorous stirring at a pH of 4, with addition of 1.1 kg of sulfuric acid (20%). The product had an average residence time of about 11 min in the 400 l mixer.

The product was transferred continuously into a second mixer, into which about 170 kg/h of filler suspension were also introduced. The average residence time in the second mixer was about 90 minutes. This process results in application of the coating layer securely bonded to the particles, to reduce tack.

A centrifuge was then used to separate the solid from the serum, and the solid was dried to a residual moisture level below 1% in a fluidized bed.

After the drying process, 1 phr of fine-particle ZnO powder was admixed with the granules in a powder mixer, so that the mechanical properties of the loose material are retained even over prolonged storage periods.

After the drying process, the product comprised 100 phr (parts per hundred parts of rubber) of solid rubber, 25 phr of process oil (Enerthene 1849 1), and 76 phr of N234 carbon black.

Evaluation of the specimen for performance characteristics and in the form of loose material revealed no differences on comparison with the reference products (e.g. products prepared as in DE 100 08 877.5).

### Example 4 (FIG. 2)

Preparation of Rubber Powder Based on Field Latex NR, Corax N234 (Wet Fluffy)

A stable suspension of 35.3 kg (TS) of Corax N234 (wet fluffy), in 770 l of water.

A pump (about 900 kg/h) was used to meter this suspension simultaneously with the NR latex (32.7% solids) to the precipitation vessel. Total throughput is 1540 kg/h. The acid-catalyzed latex coagulation onto the filler particles was carried out with vigorous stirring at a pH of 4, with addition of 4 kg of sulfuric acid (20%). The product had an average residence time of about 23 min in the 600 l mixer.

The product was transferred continuously into a second mixer, into which about 900 kg/h of filler suspension were also introduced. The average residence time in the second mixer was about 120 minutes. This process results in application of the coating layer securely bonded to the particles, to reduce tack.

A centrifuge was then used to separate the solid from the serum, and the solid was dried to a residual moisture level below 1% in a fluidized bed.

After the drying process, 1 phr of fine-particle ZnO powder was admixed with the granules in a powder mixer, so that the mechanical properties of the loose material were retained even over prolonged storage periods.

After the drying process, the product comprised 100 phr (parts per hundred parts of rubber) of solid rubber, and 47 phr of N234 carbon black, and 1 phr of ZnO.

Evaluation of the specimen for performance characteristics and in the form of loose material revealed no differences on comparison with the reference products (e.g. products prepared as in DE 100 08 877.5).

German Application 10256790.5 filed on Dec. 5, 2002 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1. A process comprising
continuously and simultaneously feeding an aqueous filler mixture comprising at least one filler, and an aqueous rubber emulsion or latex into a reactor system through separate feedlines to coagulate rubber on the surface of the filler and form a precipitation suspension of filled rubber granules, and
continuously discharging the resultant precipitation suspension from the reactor system;
wherein the reactor system comprises two or more reactors in series;
wherein coagulation is effected by lowering the pH, adding a water-soluble salt of metals of group IIa, IIb, IIIa, or VIII of the periodic table of the elements, or a combination thereof.

2. The process as claimed in claim 1, wherein the aqueous filler mixture is fed into the reactor system one or more fractions.

3. The process as claimed in claim 2, wherein at least one fraction is continuously fed into each reactor of the reactor system.

4. The process as claimed in claim 2, further comprising
continuously feeding a second aqueous filler mixture fraction to a second reactor in series.

5. The process as claimed in claim 4, further comprising
continuously feeding a third aqueous filler mixture fraction to a third reactor.

6. The process as claimed in claim 1, wherein the aqueous filler mixture and the rubber emulsion or latex, have an average residence time of from 0.1 second to 60 min in a first reactor.

7. The process as claimed in claim 1, wherein the aqueous mixture and the rubber emulsion or latex have an average residence time of from 0 to 480 min in a second and a third reactor in series.

8. The process as claimed in claim 1, wherein the pH in the first reactor is from 2.5 to 7.0.

9. The process as claimed in claim 1, wherein the pH in the first reactor is from 3.0 to 5.0.

10. The process as claimed in claim 1, further comprising
adjusting the pH to different values in each reactor, wherein the pH sequentially decreases based on the pH in a first reactor.

11. The process as claimed in claim 1, wherein the process is carried out at a temperature of from 10 to 90° C.

12. The process as claimed in claim 1, wherein the process is carried out at a temperature of from 15 to 40° C.

13. The process as claimed in claim 1, wherein the filler is a naturally occurring filler or a synthetic filler selected from the group consisting of an industrial carbon black, a precipitated silicon, a fumed silica, a clay, an activated carbon, a high-surface-area substance, individually and a mixture thereof, in a proportion of from 20 to 99.9%.

14. The process as claimed in claim 1, wherein the rubber is selected from the group consisting of a natural rubber, an emulsion SBR, a butyl-acrylonitrile rubber, a butyl rubber, a terpolymer of ethylene, a terpolymer of propylene (EPM), a terpolymer of an unconjugated diene (EPDM), a butadiene rubber, a solution SBR, an isoprene rubber, a carboxy rubber, an epoxy rubber, a trans-polypenteneamer, a halogenated butyl rubber, a rubber derived from 2-chlorobutadiene, an ethylene-vinyl acetate copolymer, an epichlorohydrin, a modified natural rubber, and epoxidized grades of a natural rubber.

15. The process as claimed in claim 1, wherein the aqueous filler mixture, the rubber emulsion or latex, or both the aqueous filler mixture and the rubber emulsion or latex, further comprise at least one selected from the group consisting of zinc oxide, zinc stearate, stearic acid, a polyalcohol, a polyamine, a plasticizer, a stabilizer, a reinforcing resin, a flame retardant, Al(OH)₃, Mg(OH)₂, a pigment, ZnO, a crosslinking chemical, and sulfur.

16. The process as claimed in claim 1, wherein the process is carried out in the presence of one or more organosilicon compounds.

17. The process as claimed in claim 1, further comprising
mechanically isolating a solid present in the precipitation suspension.

18. The process as claimed in claim 17, further comprising
comminuting or granulating the solid.

19. The process as claimed in claim 17, further comprising
drying the solid to a residual moisture level below 3%.

20. The process as claimed in claim 19, further comprising
coating the solid with a coating material.

21. The process as claimed in claim 20, wherein an amount of from 0.1 to 3 phr of the coating material is applied to the solid.

22. The process as claimed in claim 21, wherein the coating material comprises stearic acid, silica, or zinc oxide.

23. A vulcanizable rubber mixture obtained by the process as claimed in claim 1.

24. A pigment, toner or ink comprising filled rubber granules prepared by the process as claimed in claim 1.

25. An adsorbent or absorbent comprising filled rubber granules obtained by the process as claimed in claim 1.
